(19) United States
(12) Patent Application Publication
(10) Pub. No.: US 2009/0040051 A1
(43) Pub. Date: Feb. 12, 2009

(54) System and Method for Identifying First Responders in a Hazardous Environment

(76) Inventors: David A. DeRieux, King George, VA (US); Michael Manning, Chapel Hill, NC (US)

Correspondence Address: Aisha Ahmad;US Naval Research Laboratory, 4555 Overlook Ave. SW, Washington, DC, 20375, US

(21) Appl. No.: 11/836,173

(22) Filed: Aug. 9, 2007

(51) Int. Cl. G08B 23/00

(52) U.S. Cl. 340/573.1

(57) ABSTRACT

A system and method for identifying first responders at the scene of a hazardous site employs RFID technology to assemble an electronic ride list of first responders at a hazardous site. The electronic ride list is generated by polling the first responders on vehicles en route to the hazardous site. Each electronic ride list is sent to a central location, and an aggregated electronic ride list is assembled employing all of the individual electronic ride lists.

### FIELD OF THE INVENTION

The present invention is generally directed to a system and method to account for first responders in a hazardous environment. More specifically, RFID technology can be employed to account for the number and identity of first responders in a hazardous environment.

### BACKGROUND OF THE INVENTION

Currently, during a response to the scene of a hazardous site there is no system or method available to account for the number or identity of first responders. Typically, an initial visual and audio check is done of those responders entering the hazardous site and upon completion of the response, a visual and audio check is done to ensure all first responders have exited the premises. Further there is significant reliance on self reporting by the first responders. During the response, there is typically no time or personnel to devote to maintaining a list of first responders entering and exiting the hazardous site. Moreover, first responders typically enter and exit the hazardous site multiple times and via multiple locations.

Specifically, at the hazardous site, incident commanders have no reliable method for quickly and accurately determining the number and identities of first responders and on scene personnel. Accordingly, incident commanders cannot be certain if there are personnel unaccounted for in dangerous situations. The current practice among first responders and on scene personnel has been to keep paper records of a vehicle's crew onboard each vehicle, but these records are not readily available to incident commanders during emergencies and are not necessarily complete. Moreover, these papers are subject to loss and destruction, inaccurate data collection, and a variety of other shortcomings. Thus, when personnel accountability data is most needed at the site of a major emergency, it is unavailable, leaving incident commanders and offsite dispatchers without potentially lifesaving information regarding on-scene personnel.

This current solution proved highly inadequate for the supervising first responders during the events of Sep. 11, 2001. In this case, first responders repeatedly entered and exited the World Trade Center buildings with no accounting of personnel. As the tragedy unfolded, the rudimentary system of visually identifying first responders and self-reporting quickly became useless. Accordingly, a need exists for a system and method to account for first responders in a hazardous environment.

### BRIEF SUMMARY OF THE INVENTION

A system and method is provided for automatically identifying at least one of a plurality of personnel at a hazardous site. The method includes equipping personnel and vehicles responding to a hazardous environment with active RFID devices and automatically polling the active RFID devices via active RFID reading devices. This allows for creating an electronic ride list of personnel on the at least one vehicle. The electronic ride list is then sent to a central database via a wireless network.

### BRIEF DESCRIPTION OF THE DRAWINGS

The advantages and novel features of the present invention will be more readily appreciated from the following detailed description when read in conjunction with the accompanying drawings, in which:

FIG. 1 is an illustrative of an embodiment of the system in accordance with an aspect of the present invention;

FIG. 2 is a flow chart of an embodiment of the method employed by the system in accordance with an aspect of the present invention;

### DETAILED DESCRIPTION OF THE INVENTION

Radio-frequency identification (RFID) is an automatic identification method, relying on storing and remotely retrieving data using devices called RFID tags or transponders. An RFID tag is an object that can be attached to or incorporated onto a person or clothing for the purpose of identification using radio waves. Chip-based RFID tags contain silicon chips and antennas. Passive tags require no internal power source, whereas active tags require a power source.

Unlike passive RFID tags, active RFID tags have their own internal power source which is used to power any integrated circuits that generate the outgoing signal. Active tags are typically much more reliable (e.g. fewer errors) than passive tags due to the ability for active tags to conduct a “session” with a reader. In addition, active tags, due to their onboard power supply, also transmit at higher power levels than passive tags, allowing them to be more robust in the unpredictable and highly variable conditions of a hazardous site including such conditions as fire, water, chemical and environmental contaminants. Many active tags have practical ranges of hundreds of meters, and a battery life of up to 10 years. Some active RFID tags include sensors such as temperature logging which have been used in concrete maturity monitoring or to monitor the temperature of perishable goods. Other sensors that have been married with active RFID include humidity, shock/vibration, light, radiation, temperature, and atmospherics like ethylene. Active tags typically have much longer range (approximately 100 m/300 feet) and larger memories than passive tags, as well as the ability to store additional information sent by the transceiver. In addition, RFID technology allows for communication between the reader and transponder in a full duplex manner.

An embodiment of the present invention employs active RFID technology to identify first responders e.g., personnel dispatched to the scene of a hazardous environment and potentially other personnel at the scene of a hazardous site. The present invention preferably furnishes this information to other locations to better coordinate equipment and personnel at a hazardous site.

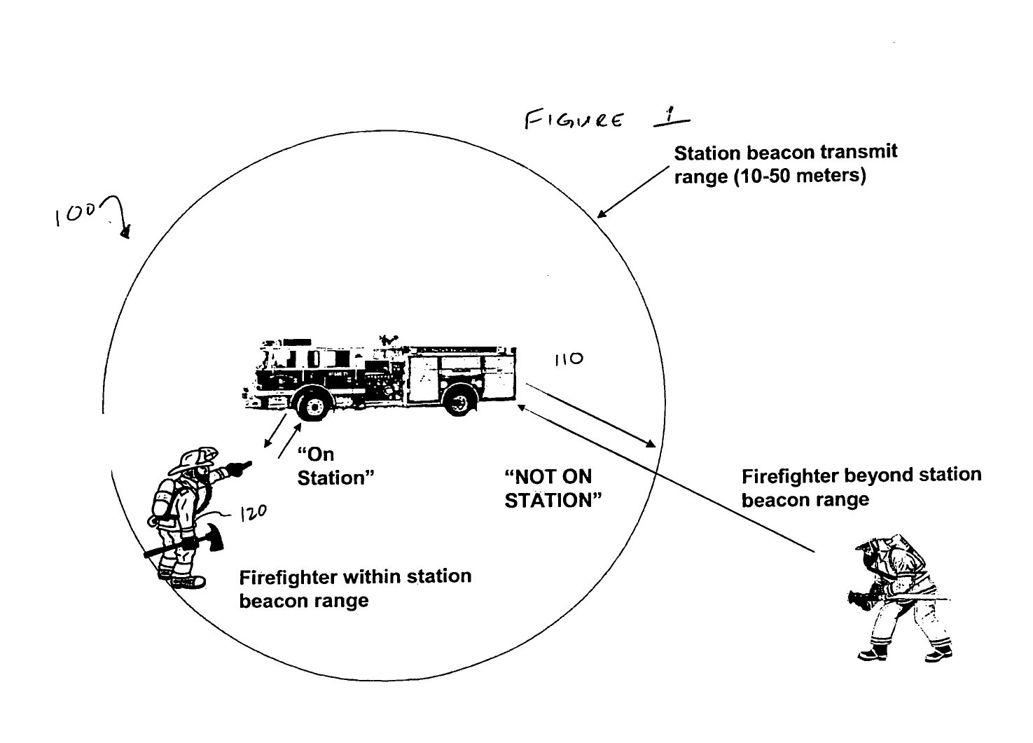

FIG. 1 is illustrative of the overall system 100 of an embodiment of the present invention. The system 100 comprises an active RFID reading device (not shown) disposed on a first responder vehicle, such as a fire truck 110, and an active RFID device (not shown) located on a first responder 120. The active RFID device can be located in the first responders clothing or any other equipment within the custody of the first responder. In operation, the first responders 120 are equipped with active RFID devices that function as transponders. These active RFID devices can be pre-programmed with a plurality of identifying information with respect to the associated first responder. For example, this identifying information can comprise the first responders name, associated fire house, badge number as well as other relevant information. The first responder vehicle 110 is also equipped with an RFID reading device employed to poll the active RFID device for identifying information as referenced above. Upon powering first responder vehicle 110 and departing for the hazardous site, the active RFID reading devices can automatically poll for the transponders of the active RFID devices coupled to the first responders 120. This polling generates an electronic ride list (ERL) comprising those first responders 120 that are located on the first responder vehicle 110. This ERL can be sent, via a wireless network, to a central database at command headquarters, for example, or to an ad-hoc network at the hazardous site, wherein the ad-hoc network couples the plurality of first responder vehicles into a network. The ad-hoc network is not limited to first responder vehicles, rather, the ad-hoc network can be comprised of other relevant parties at the hazardous site. These individual ERL's from each vehicle are used to compile an aggregated ERL for the entire incident.

The active RFID reading device can be placed in the first responder vehicle 110 or can be a portable device. If the active RFID reading device is disposed in the truck, the active RFID reading device should be disposed in a central location in order to get reliable polling from the active RFID devices coupled to the first responders 120. The central location should be such to ensure RFID coverage of all riding positions on the first responder vehicle 110. In addition, the active RFID reading device may be placed in a position so as not to require running exposed power or data cables. A display device coupled to the active RFID reading device is employed to display the information from the active RFID reading device. In an embodiment of the present invention the display device comprised a 500 MHz Fujitsu LT-C500 tablet PC, the antenna employed includes a half-dipole whip capable of being pivoted parallel with a ground plane. This type of antenna preferably provides a measure of RF gain to compensate for the loss of sensitivity caused by placing the antenna parallel to the ground plane. The display device can also be employed to display the aggregated ERL.

The active RFID device employed in the present invention includes RFID tags manufactured by Active Wave, Inc. The two models employed for testing include the AW minitag and the AW compact tag. The two tags were chosen for their extreme small size and because they employ different types of antennas. The compact tag uses a larger, more efficient antenna in order to provide more reliable communications. The mini-tag employs a smaller, more complex, yet less efficient antenna, and with a higher cost. The benefit of the smaller antenna is obviously size. However, the size issue was not as important, and though both antennae worked acceptably well, the compact tag can be a better option for the challenging environments in which the system is designed to operate. In circumstances where small sizes is of paramount importance, the minitag can be used with very little penalty in terms of range and reliability. However, both the minitas and the compact tag can be used in an embodiment of the present invention.

In order to provide a convenient and portable mounting system for the active RFID device, they can be disposed into Nomex pouches. These Nomex pouches are preferably provided with a metal quick-clip allowing them to be easily attached and detached to the first responders' clothing. Although one embodiment of the present invention includes employing a Nomex pouch, the present invention is not limited to this means of coupling the active RFID device to the first responder.

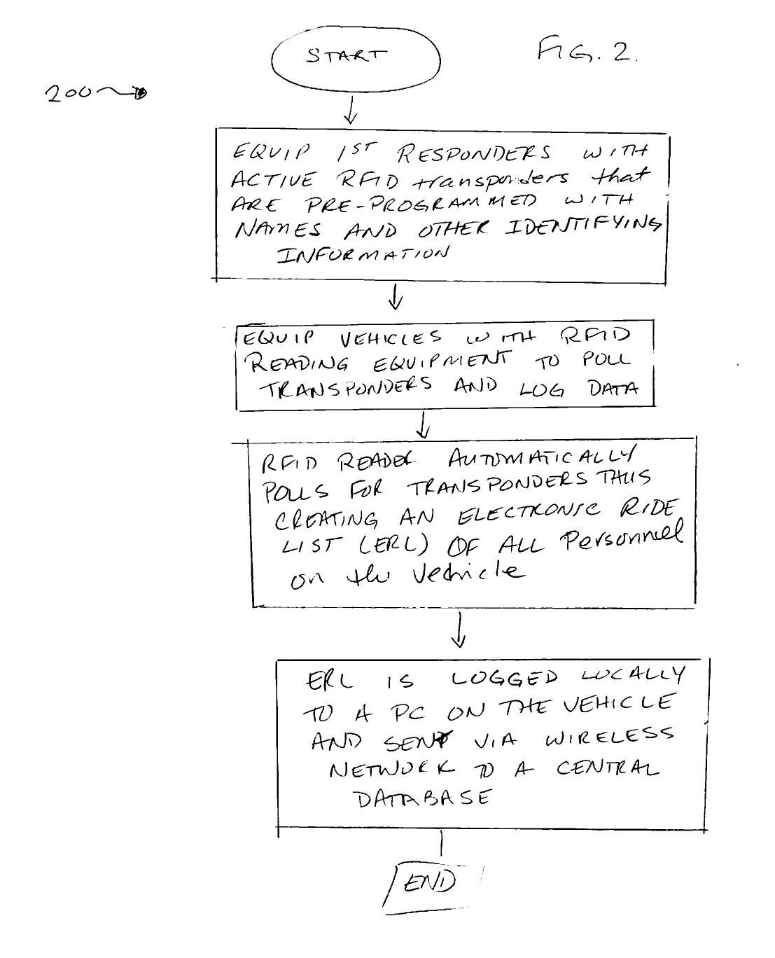

FIG. 2 is illustrative of a flow chart 200 describing an embodiment of the present invention to automatically identify first responders during a response to a hazardous site. Accordingly, when the first responder vehicle is powered in order to proceed to the hazardous site the active RFID reader device powers up and polls the active RFID devices within range, e.g, approximately 30 meters. The system 100 then generates an aggregated electronic ride list based on the polling data gathered during the power up phase. This electronic ride list is communicated to a central network capable of receiving all ERLs and then generating an aggregated ERL to send back to the vehicles at the hazardous site.

An additional embodiment of the present invention employs generating an unaccounted personnel list. A real-time roll call can be taken employing the active RFID reader device in the first responder's vehicles polling the active RFID device. As an alternative, the active RFID reader devices can be removed from the first responder's vehicle and become a portable device. The real-time roll call list is assembled by the active RFID reader device polling the active RFID devices disposed on the first responders within range of the active RFID reader device. This data is sent via a wireless network to a central location, where the unaccounted personnel list is time-stamped. This list is compared or cross checked with the aggregated electronic ride list developed from all the vehicles at the site, thus generating a missing personnel list.

A further additional embodiment of the present invention employs generating a list for shift change of personnel. A shift commander at the hazardous scene can set up a check-in/check-out station employing the portable or vehicle mounted active RFID reader device. The first responders at the hazardous scene wishing to check-out can approach the active RFID reader device and be automatically polled. The shift commander can actively check-out the relevant personnel and thereby update the list. This shift change list can be sent via a wireless network to a central location and be time stamped and used to modify the aggregated ERL, adding personnel who may have checked-in and deleting personnel who may have checked-out. The revised aggregated ERL is sent back to the hazardous site via a wireless network.

The system 100 performs a plurality of functions including, but not limited to, automatically establishing an electronic ride list (ERL) of first responders or other personnel traveling aboard the respective first response vehicles as they proceed from the “home” station, for example, a fire station, a police station, hospital or other similar first responder home station to the hazardous site or incident. The system 100 will preferably provide information, e.g., ERL, to a central database or other offsite operations center via a wireless data communication system disposed on the first response vehicle. System 100 also provides a format for displaying the ERL in a terminal on the responding vehicle. Moreover, the display on the vehicle is interactive and allows for the first responders to easily add or remove themselves from the ERL during a shift change or other situations requiring updating of the ERL. In addition to the ERL, the system 100 will also preferably provide an electronic personnel identification (EPI) system for instantly identifying and listing first responder personnel with an active RFID transponder device when the first responder is within range of the active RFID device reader. This EPI can also be sent wirelessly to the central database or other offsite operations.

The following includes the specification for the active RFID reader device:

| | |
|---|---|
| Memory: | 4k bits |
| Transmit frequency: | 916 MHz |
| Receive frequency: | 433 MHz |
| Receive Range: | 30 meters |
| Transmit Range: | 30 meters |
| Dimensions: | 34 × 32 × 12 mm (excluding rugged case) |
| Weight: | 11 grams (excluding rugged case) |
| Battery Life: | 3 years depending on use |
| Battery: | 3.3 VDC lithium watch battery |
| Operating Temperature: | −31 to +122 F. |
| Storage Temperature: | −40 to +185 F. |

The following includes the specifications for the active RFID device.

| | |
|---|---|
| Memory: | 4k bits |
| Transmit frequency: | 916 MHz |
| Receive frequency: | 433 MHz |
| Receive Range: | 30 meters |
| Transmit Range: | 30 meters |
| Dimensions: | 34 × 32 × 12 mm (excluding rugged case) |
| Weight: | 11 grams (excluding rugged case) |
| Battery Life: | 3 years depending on use |
| Battery: | 3.3 VDC lithium watch battery |
| Operating Temperature: | −31 to +122 F. |
| Storage Temperature: | −40 to +185 F. |

Although only a few exemplary embodiments of the present invention have been described in detail above, those skilled in the art will readily appreciate that many modifications are possible in the examplary embodiments without materially departing from the novel teachings and advantages of this invention. Accordingly, all such modifications are intended to be included within the scope of this invention as defined in the following claims.

What is claimed is:

1. A method for automatically identifying at least one of a plurality of personnel at a hazardous site comprising:
equipping the at least one of a plurality of personnel with an active RFID device;
equipping at least one vehicle of a plurality of vehicles with an active RFID reading device; and
automatically polling the active RFID devices via said active RFID reading device and, creating an electronic ride list of personnel on the at least one vehicle.

2. The method of claim 1, comprising:
sending the electronic ride list to a central database via a wireless network; and
compiling an aggregated electronic ride list at the central database.

3. The method of claim 1, wherein said automatically polling the active RFID devices includes polling for identification information of the at least one of a plurality of personnel and status information of the at least one of a plurality of personnel, and the hazardous site information where the at least one of a plurality of personnel are situated.

4. The method of claim 1, comprising:
said sending the electronic ride list to a central database comprising sending the electronic ride list to a central dispatch office, an ad-hoc network at the hazardous site, wherein said ad-hoc network couples the active RFID reading devices present at the hazardous site.

5. The method of claim 1, comprising:
generating a status personnel list by polling the active RFID devices of at least one of a plurality of personnel at the hazardous site;
comparing the status personnel list to the electronic ride list; and
generating an unaccounted personnel list from a result of said comparing and sending the unaccounted personnel list to a central database via a wireless network for verification and notification.

6. The method of claim 1, comprising:
generating a shift change list at the hazardous site by the active RFID devices polling each of the plurality of personnel for shift change information comprising when the each of the plurality of personnel is leaving the hazardous site, the each of the plurality of personnel responds to said polling by submitting log-off information to the active RFID device; and
updating the electronic ride list with the shift change list.

7. The method of claim 1, wherein said automatically polling includes polling en route to the hazardous site.

8. A system for automatically identifying at least one of a plurality of personnel at a hazardous site comprising:
at least one of a plurality of active RFID device for equipping the at least one of a plurality of personnel;
at least one of a plurality of active RFID reading devices for equipping at least one vehicle of a plurality of vehicles, wherein said active RFID reading devices automatically poll said active RFID devices to determine personnel on the at least one vehicle; and
an electronic ride list comprising personnel on the at least one vehicle.

9. A system as claimed in claim 8, further comprising:
a status personnel list generated by polling the active RFID devices of at least one of a plurality of personnel at the hazardous site by comparing the status personnel list to the electronic ride list; and
an unaccounted personnel list generated from a result of the comparing.

10. A system as claimed in claim 8, further comprising:
a shift change list generated at the hazardous site by the active RFID devices polling each of the plurality of personnel for shift change information comprising when the each of the plurality of personnel is leaving the hazardous site, the each of the plurality of personnel responds to said polling by submitting log-off information to the active RFID device; and
updated electronic ride list generated by said shift change list.

11. A computer readable medium set of instructions for automatically identifying at least one of a plurality of personnel at a hazardous site comprising:
a first set of instructions, adapted to equip the at least one of a plurality of personnel with an active RFID devices;
a second set of instructions, adapted to equip at least one vehicle of a plurality of vehicles with an active RFID reading device; and
a third set of instructions, adapted to automatically poll the active RFID devices via said active RFID reading device and, adapted to create an electronic ride list of personnel on the at least one vehicle.

12. A computer readable medium of instructions as claimed in claim 11, further comprising:
a fourth set of instructions adapted to generate a status personnel list by polling the active RFID devices of at least one of a plurality of personnel at the hazardous site;
a fifth set of instructions adapted to compare the status personnel list to the electronic ride list; and
a sixth set of instructions adapted to generate an unaccounted personnel list from a result of said comparing and sending the unaccounted personnel list to a central database via a wireless network for verification and notification.

13. A computer readable medium of instructions as claimed in claim 11, further comprising:
a fourth set of instructions adapted to generate a shift change list at the hazardous site by the active RFID devices polling each of the plurality of personnel for shift change information comprising when the each of the plurality of personnel is leaving the hazardous site, the each of the plurality of personnel responds to said polling by submitting log-off information to the active RFID device; and
a fifth set of instructions adapted to update the electronic ride list with the shift change list.
